(19) United States
(12) Patent Application Publication
(10) Pub. No.: US 2018/0044198 A1
(43) Pub. Date: Feb. 15, 2018

(54) SPHERICAL ZINC OXIDE PARTICLES, PROCESS FOR PRODUCING SAME, AND PLASMON SENSOR CHIP OBTAINED USING SAME

(71) Applicant: Konica Minolta, Inc., Tokyo (JP)

(72) Inventors: Natsuki ITO, Tokyo (JP); Akihiro MAEZAWA, Tokyo (JP); Keisuke MIZOGUCHI, Tokyo (JP)

(21) Appl. No.: 15/555,837

(22) PCT Filed: Mar. 2, 2016
(86) PCT No.: PCT/JP2016/056405

§ 371 Date: Sep. 5, 2017

(30) Foreign Application Priority Data
Mar. 6, 2015 (JP) 2015-044171

(51) Int. Cl. C01G 9/02

(52) U.S. Cl. CPC C01G 9/02; C01P 2004/32; C01P 2002/52; C01P 2006/60; G01N 21/41

(57) ABSTRACT

The present invention addresses the problem of providing spherical zinc oxide particles which have an average particle diameter within a specific range, have excellent monodispersity, and have a high plasmon resonance intensity. Also provided are a process for producing the spherical zinc oxide particles and a plasmon sensor chip obtained using the spherical zinc oxide particles, the chip having high sensitivity and being reduced in angle dependence during measurement. The spherical zinc oxide particles have been doped with one or more metallic elements selected from the group consisting of gallium (Ga), europium (Eu), cerium (Ce), praseodymium (Pr), samarium (Sm), gadolinium (Gd), terbium (Tb), neodymium (Nd), and ytterbium (Yb), have an average particle diameter within the range of 50 to 5,000 nm, and have a variation coefficient in particle diameter distribution within the range of 1.0 to 10%.

### TECHNICAL FIELD

The present invention relates to spherical zinc oxide particles, a production method thereof, and a plasmon sensor chip using the same.

### BACKGROUND

It has been widely investigated an optical measuring method by making use of bled out evanescent light from a reflection surface when total reflection is done by irradiation of light to a metal thin film. In particular, it is called an SPR sensor which has an optical system producing a Surface Plasmon Resonance (abbreviated as SPR) with light by using a film made of gold or silver for a reflection surface.

In a practical measurement, incident light having continuous wavelength is made enter the opposite surface of the sample with an incident angle larger than a critical angle. It is observed a trough having low reflectance with a resonating wave by an evanescent wave and a surface plasmon.

Because of the fact that a property of an object to be measured may be known by the wavelength that produces this SPR phenomenon, the SPR sensor has been used for: an immunological sensor employing an antigen-antibody reaction; detection of DNA; and detection of an interaction between a receptor and a protein.

A thin metal film used for a sensor chip of the SPR sensor is generally made of gold or silver. In this case, the light from UV light to visible light is used for SPR.

Recently, it has been conducted a development of plasmon aimed at an oxide semiconductor instead of a metal. An oxide semiconductor has a wide band gap, and the number of carriers will be arbitrary controlled. Infrared light may be used for an SPR sensor, which has been difficult to realize. It is particularly expected to apply for a biological field such as a non-invasive type blood glucose value sensor.

Among the oxide semiconductors, zinc oxide (ZnO) doped with a small amount of metal has a large carrier mobility and a large carrier density. Hence, it is easy to control the measurement wavelength region. Since it is expected to achieve high sensitivity, it attracts attention from the viewpoint of practical realization.

On the other hand, instead of a SPR sensor using a thin metal film, it may be used a plasmon sensor which utilizes a plasmon resonance of a particle surface. This kind of plasmon resonance has a small amount of angle dependence of incident light, and it enables to conduct stable measurement, which is different from an SPR sensor using a thin metal film. In addition, it has an advantage of producing the sensor with a low cost.

In order to effectively make plasmon resonance by using particles, it is preferable to use monodispersed spherical particles having a small particle diameter. Patent document 1 discloses spherical zinc oxide particles having high sphericity. However, the particles have a large particle diameter and low monodispersity. Therefore, these particles were not appropriately used for a plasmon sensor. Patent document 2 discloses spherical zinc oxide particles of high sphericity having a small particle diameter. However, they have low sphericity, and they were not appropriately used for a plasmon sensor. Consequently, it was expected to find spherical zinc oxide particles having a small particle diameter enabling to effectively make plasmon resonance.

### PRIOR ART DOCUMENTS

### Patent Documents

Patent document 1: Japanese Patent No. 5617410

Patent document 2: JP-A 2013-60375

### SUMMARY OF THE INVENTION

### Problems to be Solved by the Invention

The present invention has been made in view of the above-described problems and situation. An object of the present invention is to provide spherical zinc oxide particles having a particle diameter in a specific range and excellent in monodispersity with exhibiting plasmon resonance of high intensity. An object of the present invention is also to provide a production method thereof, and a plasmon sensor chip using the same having high sensitivity and a small angle dependence of incident light during measurement.

### Means to Solve the Problems

The present inventors have investigated the shape of the spherical zinc oxide particles doped with a metallic element and the intensity of the plasmon resonance in order to solve the above-described problems. It was found that the spherical zinc oxide particles doped with a specific metallic element having a particle diameter in a specific range and excellent in monodispersity and having high sphericity exhibit high plasmon resonance intensity. Thus, the present invention has been achieved.

That is, the above-described problems of the present invention are solved by the following embodiments.

1. Spherical zinc oxide particles doped with a metallic element selected from the group consisting of gallium, europium, cerium, praseodymium, samarium, gadolinium, terbium, niobium and ytterbium,

wherein the spherical zinc oxide particles have an average particle diameter in the range of 50 to 5,000 nm, and have a variation coefficient in particle diameter distribution in the range of 1.0 to 10%.

2. The spherical zinc oxide particles described in the embodiment 1,

wherein a total dope amount of the metallic element is in the range of 0.01 to 10.00 mol %.

3. The spherical zinc oxide particles described in the embodiment 1,

wherein a total dope amount of the metallic element is in the range of 0.01 to 7.00 mol %.

4. The spherical zinc oxide particles described in any one of the embodiments 1 to 3,

wherein the spherical zinc oxide particles have an average aspect ratio in the range of 1.00 to 1.15.

5. The spherical zinc oxide particles described in any one of the embodiments 1 to 4,

wherein the metallic element is gallium.

6. The spherical zinc oxide particles described in any one of the embodiments 1 to 5,

wherein the spherical zinc oxide particles have a variation coefficient in the range of 1.0 to 8.0%.

7. A method for producing spherical zinc oxide particles comprising the steps of:

forming zinc compound precursor particles by mixing an aqueous metallic element solution, an aqueous zinc solution, and an aqueous urea solution, the metallic element in the aqueous metallic element solution being one selected from the group consisting of gallium, europium, cerium, praseodymium, samarium, gadolinium, terbium, niobium, and ytterbium; and

calcining the zinc compound precursor particles to obtain spherical zinc oxide particles doped with the metallic element.

8. The method for producing spherical zinc oxide particles described in the embodiment 7,

wherein in the step of forming the zinc compound precursor particles, at least one of the aqueous zinc solution, the aqueous metallic element solution, and the aqueous urea solution is added into a reaction solution in which formation of the zinc compound precursor particles is in progress.

9. A plasmon sensor chip provided with: the spherical zinc oxide particles described in any one of the embodiments 1 to 6; and a substrate.
10. The plasmon sensor chip described in the embodiment 9 having a transmitting property and having a refractive index in the range of 1.30 to 4.00.

### Effects of the Invention

By adopting a constitution of the present invention, it may provide spherical zinc oxide particles having a particle diameter in a specific range and excellent in monodispersity with exhibiting plasmon resonance of high intensity. It may also provide a production method thereof, and a plasmon sensor chip using the same having high sensitivity and a small angle dependence of incident light during measurement.

### BRIEF DESCRIPTION OF THE DRAWINGS

FIG. 1 is a schematic drawing illustrating an example of a plasmon sensor using a plasmon sensor chip.

FIG. 2 is an example of a scanning microscopic picture of spherical zinc oxide particles.

### EMBODIMENTS TO CARRY OUT THE INVENTION

The embodiments of the present invention will be described in the following. In the present description, when two figures are used to indicate a range of value before and after “to”, these figures are included in the range as a lowest limit value and an upper limit value.

### <<Spherical Zinc Oxide Particles>>

The spherical zinc oxide particles of the present invention are doped with a metallic element selected from the group consisting of: gallium (Ga), europium (Eu), cerium (Ce), praseodymium (Pr), samarium (Sm), gadolinium (Gd), terbium (Tb), niobium (Nd) and ytterbium (Yb). The spherical zinc oxide particles have an average particle diameter in the range of 50 to 5,000 nm, and have a variation coefficient in particle diameter distribution in the range of 1.0 to 10%. These spherical zinc oxide particles have relatively small average particle diameter, and they are excellent in monodispersity. They exhibit high plasmon resonance intensity, and they are useful for achieving a plasmon sensor chip with a small angle dependence of incident light.

### <Metallic Element to be Doped>

The spherical zinc oxide particles are doped with a metallic element doped with one selected from the group consisting of: gallium (Ga), europium (Eu), cerium (Ce), praseodymium (Pr), samarium (Sm), gadolinium (Gd), terbium (Tb), niobium (Nd) and ytterbium (Yb). Different from a SPR sensor employing a metal, by doping a metallic element to semiconductor zinc oxide having a large band gap, the number of carriers will be controlled. It may be controlled the plasmon resonance wavelength in the range of visible to infrared region. This kind of control may be conducted by the species and the content of metallic element to be doped.

Preferable metallic elements used for doping are Ga or Eu. Most preferable metallic element is Ga. In addition, several kinds of metallic elements may be suitably selected according to the purpose. Besides, other metallic element may be included as long as it does not deteriorate appearance of plasmon resonance.

A total dope amount of the metallic element is preferably in the range of 0.01 to 10.00 mol %. More preferably, it is in the range of 0.01 to 7.00 mol %.

Here, a content of the metallic element contained in the spherical zinc oxide particles may be determined with an elemental analysis. For example, it may be determined as follows. One gram of sample is dissolved in a mixture solution of 10 mL of aqueous nitric acid solution and 1.0 mL of hydrogen peroxide solution. An elemental analysis is done to this by using an ICP Atomic emission spectrometry (ICP-AES). From the content of each metallic element in the spherical zinc oxide particles, a composition ratio (mol %) may be obtained.

A composition distribution of the spherical zinc oxide particles may be determined by carrying out an elemental analysis to a cross-section of the spherical zinc oxide particles. For example, it may be determined as follows. A cross-section treatment is done to the spherical zinc oxide particles by using a condensed ion beam device (FB-2000A, made by Hitachi High Technologies Co. Ltd.). The surface across the center of the particle is cut out. An elemental analysis is done to the cross-section by using STEM-EDX (HD-2000) (made by Hitachi High Technologies Co. Ltd.). The composition distribution of each metallic element in the spherical zinc oxide particles may be thus obtained.

### <Shape of Spherical Zinc Oxide Particles>

The spherical zinc oxide particles of the present invention have an average particle diameter in the range of 50 to 5,000 nm, and have a variation coefficient in particle diameter distribution in the range of 1.0 to 10%. By making these ranges, it may be enhanced absorption intensity in the plasmon resonance frequency.

“Spherical” is determined based on a scanning microscopic picture (SEM image) of the spherical zinc oxide particles. Specifically, a scanning microscopic picture of the spherical zinc oxide particles is taken. Then, arbitral 100 spherical zinc oxide particles are selected. A major axis “a” and a minor axis “b” of each selected particle are obtained. An average value of “a/b” is determined as an aspect ratio. When a rectangle that circumscribes each particle (it is called as “a circumscribed rectangle) is drawn, among a short side and a long side of the circumscribed rectangle, a shortest length of the short side is made to be a minor axis, and a largest length of the long side is made to be a major axis.

When the aspect ratio is in the range of 1.00 to 1.15, more preferably in the range of 1.00 to 1.05, the particles are classified as “spherical”. When the aspect ratio is outside the range of 1.00 to 1.15, the particles are classified as “amorphous”. When the aspect ratio is nearer to 1, it means that the sphericity is high.

When the aspect ratio is larger than 1.15, uniformity of the spherical zinc oxide particles becomes lost and the absorption intensity at the plasmon resonance frequency becomes low.

The spherical zinc oxide particles have an average particle diameter in the range of 50 to 5,000 nm. When it is less than 50 nm, it may be produced aggregation during preparation of the particles. In addition, when it is larger than 5,000 nm, an efficient plasmon resonance may not be obtained. It is not preferable. Preferably, the average particle diameter is in the range of 50 to 3,000 nm, and more preferably, it is in the range of 80 to 2,500 nm.

An average particle diameter may be obtained as follows. Based on a picture image of arbitrary selected 100 spherical zinc oxide particles, a particle diameter of a circle having an equivalent area is determined. An average particle diameter may be obtained by this value.

The spherical zinc oxide particles have a variation coefficient in particle diameter distribution in the range of 1.0 to 10%. When the variation coefficient in particle diameter distribution is larger than 10%, an efficient plasmon resonance may not be obtained. It is not preferable. A preferable variation coefficient is 1.0 to 8.0%, and more preferable variation coefficient is in the range of 1.0 to 7.0%.

A variation coefficient in particle diameter distribution may be determined based on a variation coefficient in particle diameter distribution obtained from a scanning microscopic picture (SEM image) of a predetermined number of spherical zinc oxide particles.

For example, a variation coefficient in particle diameter distribution is obtained from the SEM images of 100 spherical zinc oxide particles. It may be called as monodispersity. The monodispersity may be evaluated. The variation coefficient in particle diameter distribution is determined by the following relationship.

Variation coefficient (%)=(Standard deviation in particle diameter distribution/Average particle diameter)×100

Here, the particle diameter and the particle diameter distribution may be measured using an image processing measuring apparatus (for example, LUZEX AP, made by Nireco Co. Ltd.).

### <<Production Method of Spherical Zinc Oxide Particles>>

A method for producing spherical zinc oxide particles of the embodiment of the present invention is characterized in containing the following steps: forming zinc compound precursor particles by mixing an aqueous metallic element solution, an aqueous zinc solution, and an aqueous urea solution, the metallic element in the aqueous metallic element solution being one selected from the group consisting of gallium (Ga), europium (Eu), cerium (Ce), praseodymium (Pr), samarium (Sm), gadolinium (Gd), terbium (Tb), niobium (Nd) and ytterbium (Yb); and calcining the zinc compound precursor particles.

In the present embodiment, the spherical zinc oxide particles may be obtained as follows. The zinc compound precursor particles are produced by mixing and heating: an aqueous zinc solution, an aqueous metallic element solution, and an aqueous urea solution. Then, the produced zinc compound precursor particles are calcined.

A method for producing spherical zinc oxide particles of the present embodiment contains the following steps. The steps include: a step of forming zinc compound precursor particles by mixing an aqueous zinc solution, an aqueous metallic element solution, and an aqueous urea solution; and a step of calcining the zinc compound precursor particles (it may be called as a calcining step). Preferably, the production method contains the four steps as described in the following: “raw material solution preparation step”, “zinc compound precursor particles forming step”, “solid-liquid separation step”, and “zinc compound precursor particles calcining step”.

### 1. Raw Material Solution Preparation Step

A raw material solution preparation step is a step for preparing: an aqueous zinc solution; an aqueous metallic element solution; and an aqueous urea solution, which are raw materials.

### <Preparation Step of Aqueous Urea Solution>

A preparation step of an aqueous urea solution is a step for preparing an aqueous urea solution having a predetermined density.

Examples of urea include: urea, salts of urea (for example, nitrate, hydrochloride), N,N′-dimethylacetylurea, N,N′-dibenzoylurea, benzenesulfonylurea, p-toluenesulfonylurea, trimethylurea, tetraethylurea, tetramethylurea, Triphenylurea, tetraphenylurea, N-benzoylurea, methylisourea, ethylisourea, ammonium carbonate, and ammonium hydrogen carbonate.

An aqueous urea solution acts as a precipitant. When a zinc oxide aqueous solution and an aqueous metallic element solution are heated by mixing with water, it is conceived that zinc compound precursor particles is produced as a basic carbonate. Among the above-described urea derivatives, urea is preferably used since it decomposes gradually, and precipitation will proceed slowly, and uniform precipitation will be obtained.

An aqueous urea solution is an aqueous solution containing a urea derivative. It may be prepared by mixing the above-described urea derivative and water. It may be added an additive such as a pH adjusting agent when needed.

Although a concentration of the aqueous urea solution is not limited in particular, it is preferable to be in the range of 0.01 to 10.00 mol/L. It is more preferable to be in the range of 0.10 to 5.00 mol/L.

### <Preparation Step of Aqueous Metallic Element Solution>

A preparation step of an aqueous metallic element solution is a step for preparing an aqueous metallic element solution containing a metallic element selected from the group consisting of gallium (Ga), europium (Eu), cerium (Ce), praseodymium (Pr), samarium (Sm), gadolinium (Gd), terbium (Tb), niobium (Nd) and ytterbium (Yb).

A nitrate, a hydrochloride or a sulfate of these elements may be used for preparing an aqueous solution of these metals. A preferable salt is a nitrate. Thereby, it may be produced spherical zinc oxide particles with small amount of impurities.

Although an ion concentration of the aqueous metallic element solution is not limited in particular, it is preferable that it is in the range of 0.00001 to 5.00 mol/L. It is more preferable that it is in the range of 0.0001 to 3.00 mol/L.

The aqueous metallic element solution may contain one kind of metal, and it may contain a plurality of metals.

### <Preparing Step of Aqueous Zinc Solution>

A preparation step of an aqueous zinc solution is a step for preparing an aqueous solution containing a zinc element. As a zinc salt which may be used for preparing an aqueous solution containing a zinc element, a nitrate, a hydrochloride or a sulfate of these elements may be used therefor. A preferable salt is a nitrate. Thereby, it may be produced spherical zinc oxide particles with small amount of impurities.

Although an ion concentration of the aqueous zinc solution is not limited in particular, it is preferable that it is in the range of 0.0001 to 10.00 mol/L. It is more preferable that it is in the range of 0.001 to 5.00 mol/L.

### 2. Zinc Compound Precursor Particles Forming Step

A zinc compound precursor particles forming step is a step which forms zinc compound precursor particles by mixing: an aqueous zinc solution; an aqueous metallic element solution; and an aqueous urea solution.

In a zinc compound precursor particles forming step, it may be formed zinc compound precursor particles by mixing an aqueous zinc solution, an aqueous metallic element solution, and an aqueous urea solution together. Otherwise, it may be formed zinc compound precursor particles by adding at least one of the aqueous zinc solution, the aqueous metallic element solution, and the aqueous urea solution into a reaction solution in which formation of the zinc compound precursor particles is in progress.

It is not clearly identified a mechanism of obtaining the spherical zinc oxide particles which have a particle diameter in a specific range, excellent in high monodispersity, and high plasmon resonance intensity by the production method of the spherical zinc oxide particles of the present embodiment. However, it is considered as follows. During the formation of the zinc compound precursor particles formed from the aqueous zinc solution, the incorporated urea is gradually and uniformly decomposed. Thereby basic carbonate of zinc may be produced uniformly. As a result, it is assumed to obtain spherical zinc oxide particles with uniform particle diameter distribution.

In addition, the spherical zinc oxide particles are produced via formation of basic carbonate, and the basic carbonate may be remained in the particles.

Accordingly, it is preferable that an initial reaction solution is a mixed solution of an aqueous zinc solution and an aqueous urea solution. Here, “a reaction solution” indicates a liquid formed by mixing at least two of: an aqueous urea solution, an aqueous zinc solution, and an aqueous metallic element solution.

The reaction solution preferably has a temperature which enables to make hydrolysis of the urea derivative. Specifically, a temperature of the reaction solution is preferably from 75 to 100° C., more preferably from 80 to 100° C., and still more preferably from 90 to 100° C. It is preferable to stir the reaction solution while heating it to have a temperature in the above-described range. Thereby the ingredients of the reaction solution may be kept uniform.

When a component aqueous solution is added into a reaction solution in which formation of the zinc compound precursor particles is in progress, the component aqueous solution may be any one of the aqueous zinc solution, the aqueous metallic element solution, and the aqueous urea solution. It may be added a plurality of the component aqueous solutions. For example, by adding the aqueous metallic element solution into a mixture of the aqueous zinc solution and the aqueous urea solution, it may be controlled the position of the metallic element in the zinc compound precursor particles.

Further, the aqueous urea solution may be added into a reaction solution in which formation of the zinc compound precursor particles is in progress by mixing the aqueous zinc solution, the aqueous metallic element solution, and the aqueous urea solution. As described above, by adding the aqueous urea solution which becomes a raw material, it may be obtained the spherical zinc compound precursor particles having excellent monodispersity with keeping a good particle diameter distribution.

An addition rate of the aqueous solution is preferably in the range of 0.00001 to 1.00 mol/minute for 1 L of the reaction solution. More preferably, it is in the range of 0.0001 to 0.50 mol/minute.

The duration of addition of the aqueous solution is preferably in the range of 30 to 240 minutes. More preferably, it is in the range of 60 to 180 minutes.

A total dope amount of the metallic element in the spherical zinc oxide particles is a ratio of the metallic element to zinc in the zinc compound precursor particles. Therefore, the total dope amount may be easily adjusted by changing the ratio of the aqueous zinc solution and the aqueous metallic element solution to be added.

A stirring term is preferably in the range of 30 minutes to 10 hours. Particularly preferable stirring term is in the range of 1 to 3 hours. The heating temperature and the stirring term may be suitably adjusted to the requested particle diameter.

In the heating and stirring step of forming the zinc compound precursor particles, the shape of the stirrer is not limited in particular as long as sufficient stirring effect is obtained. In order to obtain high stirring efficiency, it is preferable to use a rotor-stator type stirrer.

### 3. Solid-Liquid Separation Step

After heating and stirring the reaction solution, the produced precipitation (the precursor of the spherical zinc oxide particles) is separated from the solution. This is a solid-liquid separation step. A method for solid-liquid separation may be a generally known method. For example, the precursor of the spherical zinc oxide particles may be obtained by filtration with a filter.

### 4. Calcining Step

In a step of calcining (it may be called as Calcining step), the precursor of the spherical zinc oxide particles, which is obtained by the solid-liquid separation step, is calcined under air or an oxidizing atmosphere at 200° C. or more. The calcined precursor of the spherical zinc oxide particles becomes an oxide compound. Thereby the spherical zinc oxide particles containing a metallic element are obtained. The calcining temperature is preferably in the range of 300 to 600° C.

When needed, calcining may be done after washing the precursor with water or alcohol and then drying.

After completing of the calcining step, the spherical zinc oxide particles are stabilized by cooling. Thus, the spherical zinc oxide particles may be obtained.

By using the production method of spherical zinc oxide particles as described above, it may be obtained the spherical zinc oxide particles having high sphericity almost without containing anisotropically grown spherical zinc oxide particles.

### <<Plasmon Sensor Chip>>

A plasmon sensor chip of the present embodiment contains the above-described spherical zinc oxide particles and the substrate. The spherical zinc oxide particles are used for a chip that produces plasmon resonance in a plasmon sensor chip.

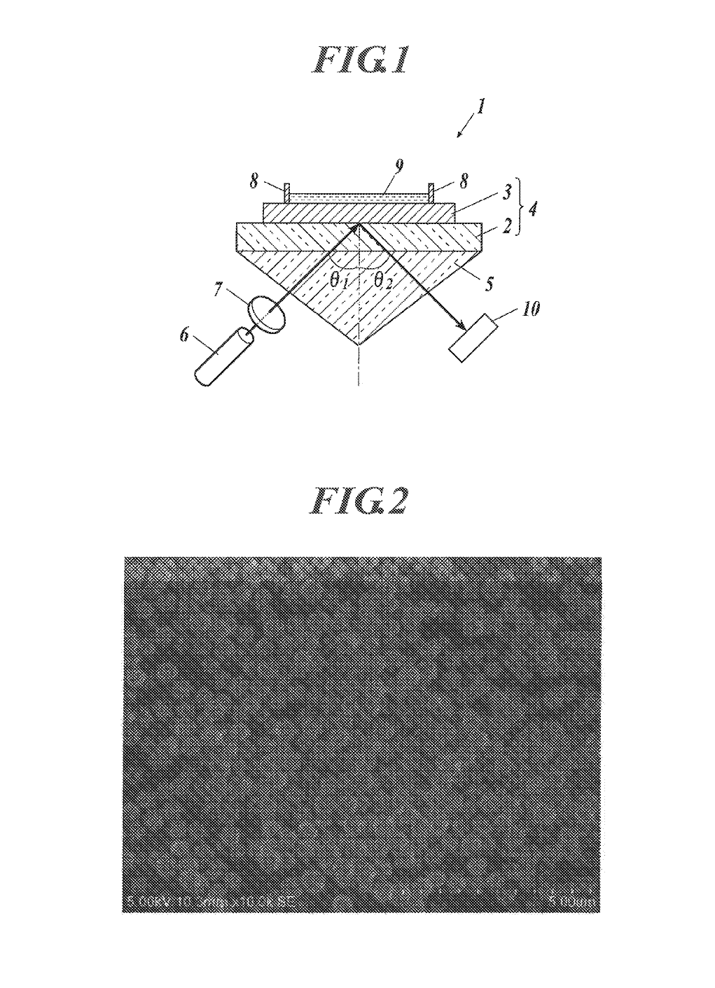

FIG. 1 illustrates an example of a plasmon sensor using a plasmon sensor chip. This plasmon sensor 1 contains a plasmon sensor chip 4 comprising a substrate 2 having thereon a layer 3 that contain spherical zinc oxide particles. The plasmon sensor 1 has a structure in which an optical prism 5 is placed in close contact to the opposite side of the substrate 2 having the layer 3 that contains spherical zinc oxide particles. A specimen 9 is fixed on the layer 3 that contain spherical zinc oxide particles with a mounting section 8.

Near infrared light emitted from a light source 6 is polarized through a polarizing plate 7, and it irradiates the transparent substrate 2 though the optical prism 5. The incident light enters with an incident angle θ₁ having a condition of total reflection. By an evanescent wave of the incident light that bled out on the surface side of the spherical zinc oxide particles, a localized plasmon resonance is generated at a predetermined wavelength. This is carried out using infrared light having different wavelength. When the surface plasmon resonance is generated, the evanescent wave is absorbed by a surface plasmon. As a result, reflection intensity is remarkably decreased. A functional group existing in the molecule may be quantitatively measured from this resonance frequency. An amount of the light reflected at a reflection angle θ₂ is measured by a light receiving section 10.

In the plasmon sensor of the present embodiment, the difference of the surface condition among the particles become small by using the spherical zinc oxide particles excellent in monodispersity and having high sphericity. As a result, it is conceived that a surface plasmin resonance is easily and accurately generated with restrained angle dependency.

### <Substrate>

It is preferable that the substrate used for a plasmon sensor chip has transparency, in particular, has transparency from the visible to the infrared region. A refractive index of the substrate is preferably in the range of 1.30 to 4.00. More preferably, a refractive index is in the range of 1.40 to 3.00. For example, glass and resin are preferably used.

Various kinds of known resin films may be used as a resin substrate. Examples thereof include: a cellulose ester film, a polyester film, a polycarbonate film, a polyallylate film, a polysulfone (including polyethersulfone) film, a polyester film such as polyethylene terephthalate and polyethylene naphthalate, a polyethylene film, a polypropylene film, cellophane, a cellulose di acetate film, a cellulose triacetate film, a cellulose acetate propionate film, a cellulose acetate butyrate film, a polyvinylidenechloride film, a polyvinyl alcohol film, an ethylene vinyl alcohol film, a syndiotactic polystyrene film, a poly carbonate film, a norbornene resin film, a polymethyl pentene film, a polyether ketone film, a polyether ketone imide film, a polyamide film, a fluororesin film, a nylon film, a polymethyl methacrylate film, and an acrylic film. Among them, preferable are: a polycarbonate film, a polyester film such as polyethylene terephthalate, a norbornene resin film, a cellulose ester film, and an acrylic film. Particularly preferable are: a polyester film such as polyethylene terephthalate and an acrylic film. The resin film may be a film produced with a melt cast film forming method or a solution cast film forming method.

A thickness of the substrate is preferably in the range of 0.001 to 10 mm.

### <Formation of Layer Containing Spherical Zinc Oxide Particles>

Various formation methods may be used for forming a layer containing spherical zinc oxide particles on a substrate. Examples thereof are: spray coating, inkjet coating, dispenser coating, slit coating, roll coating, spin coating, and dip coating. For forming the layer containing spherical zinc oxide particles, it is preferable to carry out the following: coating a liquid containing the spherical zinc oxide particles dispersed in a dispersing medium such as water or alcohol; removing the dispersing medium by drying after the coating.

A thickness of a layer containing spherical zinc oxide particles is preferably in the range of 50 nm to 50 μm from the viewpoint of obtaining highly effective plasmon resonance. More preferably, the thickness is in the range of 50 nm to 10 μm.

### EXAMPLES

Hereafter, the present invention will be described specifically by referring to examples, however, the present invention is not limited to them. In examples, the indication of “part” or “%” is used. Unless particularly mentioned, it represents “mass part” or “mass %”.

### <<Preparation of Zinc Oxide Particles 1>>

(1) 1.00 L of 2.10 mol/L aqueous urea solution was prepared.
(2) 500 mL of 0.10 mol/L aqueous gallium nitrate solution was prepared.
(3) Water was added to 500 mL of 0.90 mol/L aqueous zinc nitrate solution so as to make the solution to be 8.5 L.
(4) The aqueous zinc nitrate solution prepared in the step (3) was heated to 90° C.
(5) To the aqueous zinc nitrate solution heated in the step (4) were added the aqueous urea solution prepared in the step (1) and the aqueous gallium nitrate solution prepared in the step (2). Then the mixed solution was heated and stirred for one hour.
(6) The precursor particles precipitated after heating and stirring of the mixed solution in the step (5) were filtered with a membrane filter.
(7) The separated precursor particles in the step (6) were calcined at 400° C. to obtain zinc oxide particles 1.

### <<Preparation of Zinc Oxide Particles 2>>

(1) 1.0 L of 2.10 mol/L aqueous urea solution was prepared.
(2) 500 mL of 0.0001 mol/L aqueous gallium nitrate solution was prepared.
(3) Water was added to 500 mL of 1.00 mol/L aqueous zinc nitrate solution so as to make the solution to be 8.5 L.
(4) The aqueous zinc nitrate solution prepared in the step (3) was heated to 90° C.
(5) To the aqueous zinc nitrate solution heated in the step (4) were added the aqueous urea solution prepared in the step (1) and the aqueous gallium nitrate solution prepared in the step (2). Then the mixed solution was heated and stirred for one hour.
(6) The precursor particles precipitated after heating and stirring of the mixed solution in the step (5) were filtered with a membrane filter.
(7) The separated precursor particles in the step (6) were calcined at 400° C. to obtain zinc oxide particles 2.

### <<Preparation of Zinc Oxide Particles 3>>

(1) 1.0 L of 2.10 mol/L aqueous urea solution was prepared.
(2) 500 mL of 0.07 mol/L aqueous gallium nitrate solution was prepared.
(3) Water was added to 500 mL of 0.93 mol/L aqueous zinc nitrate solution so as to make the solution to be 8.5 L.
(4) The aqueous zinc nitrate solution prepared in the step (3) was heated to 90° C.
(5) To the aqueous zinc nitrate solution heated in the step (4) were added the aqueous urea solution prepared in the step (1) and the aqueous gallium nitrate solution prepared in the step (2). Then the mixed solution was heated and stirred for one hour.
(6) The precursor particles precipitated after heating and stirring of the mixed solution in the step (5) were filtered with a membrane filter.
(7) The separated precursor particles in the step (6) were calcined at 400° C. to obtain zinc oxide particles 3.

### <<Preparation of Zinc Oxide Particles 4>>

(1) 1.0 L of 2.10 mol/L aqueous urea solution was prepared.
(2) 500 mL of 0.05 mol/L aqueous gallium nitrate solution was prepared.
(3) Water was added to 500 mL of 0.95 mol/L aqueous zinc nitrate solution so as to make the solution to be 8.5 L.
(4) The aqueous zinc nitrate solution prepared in the step (3) was heated to 90° C.
(5) To the aqueous zinc nitrate solution heated in the step (4) were added the aqueous urea solution prepared in the step (1) and the aqueous gallium nitrate solution prepared in the step (2). Then the mixed solution was heated and stirred for one hour.
(6) The precursor particles precipitated after heating and stirring of the mixed solution in the step (5) were filtered with a membrane filter.
(7) The separated precursor particles in the step (6) were calcined at 400° C. to obtain zinc oxide particles 4.

### <<Preparation of Zinc Oxide Particles 5 to 12>>

Zinc oxide particles 5 to 12 were prepared in the same manner as preparation of the zinc oxide particles 1 except that the aqueous gallium nitrate solution was changed to aqueous europium nitrate solution, aqueous cerium nitrate solution, aqueous praseodymium nitrate solution, aqueous samarium nitrate solution, aqueous gadolinium nitrate solution, aqueous terbium nitrate solution, aqueous neodymium nitrate solution, and aqueous ytterbium nitrate solution each having the same concentration.

### <<Preparation of Zinc Oxide Particles 13>>

(1) 1.0 L of 2.10 mol/L aqueous urea solution was prepared.
(2) 500 mL of 0.073 mol/L aqueous gallium nitrate solution was prepared.
(3) Water was added to 500 mL of 0.97 mol/L aqueous zinc nitrate solution so as to make the solution to be 8 L.
(4) To the aqueous zinc nitrate solution prepared in the step (3) were added the aqueous urea solution prepared in the step (1) and the aqueous gallium nitrate solution prepared in the step (2). The mixed solution was heated to 90° C.
(5) To the dispersion solution in the step (4) was added a mixture made of 600 mL of 0.035 mol/L aqueous gallium nitrate solution and 600 mL of 0.50 mol/L aqueous zinc nitrate solution with an addition rate or 10 mL/min while heating at 90° C. with stirring.
(6) After completion of addition, the precursor particles precipitated after heating and stirring of the mixed solution in the step (5) were filtered with a membrane filter.
(7) The separated precursor particles in the step (6) were calcined at 400° C. to obtain zinc oxide particles 13.

### <<Preparation of Zinc Oxide Particles 14>>

(1) ZnO powders containing 10 mol % of Ga were pressed at 200 kg/cm² to form a target. Then the pressed target was calcined at a temperature of 1,000° C. for 24 hours to obtain a calcined ZnO target.
(2) A glass substrate was successively subjected to an ultrasonic wave washing with a neutral detergent, water, and acetone.
(3) The ZnO target was placed in a film forming chamber, and the glass substrate was placed in parallel and opposite to the ZnO target. The distance between the ZnO target and the glass substrate was set to be 30 mm.
(4) After evacuation the inside of the film forming chamber to 1×10⁻⁶ Torr, an oxygen gas was supplied in the film forming chamber to achieve 1×10⁻⁴ Torr.
(5) After heating the glass substrate to 500° C. with a heater, the ZnO target was irradiated with ArF excimer laser (5 Hz pulse laser, energy density of about 1 J/cm²). A film was formed with a film forming rate of 4 nm/min.

### <<Preparation of Zinc Oxide Particles 15>>

(1) 1.00 L of 1.40 mol/L aqueous urea solution was prepared.
(2) 500 mL of 0.10 mol/L aqueous gallium nitrate solution was prepared.
(3) Water was added to 500 mL of 0.90 mol/L aqueous zinc nitrate solution so as to make the solution to be 8.5 L.
(4) The aqueous zinc nitrate solution prepared in the step (3) was heated to 90° C.
(5) To the aqueous zinc nitrate solution heated in the step (4) were added the aqueous urea solution prepared in the step (1) and the aqueous gallium nitrate solution prepared in the step (2). Then the mixed solution was heated and stirred for 3 hours.
(6) The precursor particles precipitated after heating and stirring of the mixed solution in the step (5) were filtered with a membrane filter.
(7) The separated precursor particles in the step (6) were calcined at 400° C. to obtain zinc oxide particles 15.

### <<Preparation of Zinc Oxide Particles 16>>

(1) 1.00 L of 1.40 mol/L aqueous urea solution was prepared.
(2) 500 mL of 0.10 mol/L aqueous gallium nitrate solution was prepared.
(3) Water was added to 500 mL of 0.90 mol/L aqueous zinc nitrate solution so as to make the solution to be 8.5 L.
(4) The aqueous zinc nitrate solution prepared in the step (3) was heated to 78° C.
(5) To the aqueous zinc nitrate solution heated in the step (4) were added the aqueous urea solution prepared in the step (1) and the aqueous gallium nitrate solution prepared in the step (2). Then the mixed solution was heated and stirred for 3 hours.
(6) The precursor particles precipitated after heating and stirring of the mixed solution in the step (5) were filtered with a membrane filter.
(7) The separated precursor particles in the step (6) were calcined at 400° C. to obtain zinc oxide particles 16.

### <<Preparation of Zinc Oxide Particles 17>>

Water was added to 14.87 g of zin nitrate hexahydrate to make the total volume of 500 mL. To the solution was added 1.28 g of gallium nitrate hydrate and it was dissolved. Then, 250 g of ethylene glycol was added, and further, 62.5 g of triethanolamine was added, and the mixture was stirred. Then, the mixed solution was heated to 90° C. with a temperature rising rate of 2° C./min. After attaining to 90° C., the mixed solution was kept to 90° C. for one hour. After that, washing with water, filtering, and drying were done. Thereby spherical powders of 300 nm were obtained in a spherical aggregated state. The primary particle diameter was 10 nm. Then, the spherical powders were subjected to calcining at 400° C. for 2 hours. Thus zinc oxide particles 17 in a spherical powder state were obtained.

### <<Preparation of Zinc Oxide Particles 18>>

600 g of fine particle zinc oxide and 138 g of gallium oxide were repulped by water. It was added 3.50 mass % of dispersing agent (Poise 532A made by Kao Co. Ltd.) based on the mass of the fine particle zinc oxide. Then, 0.61 mass % f acetic acid was mixed to prepare a slurry having a concentration of 600 g/L. The obtained slurry was spray-dried to form granulated particles. They were introduced in a sagger made of mullite or mullite-cordierite, and calcined in a still state at 1150° C. for 3 hours. After cooling, they were dispersed in 1.0 L of water. They were filtered through a 200 mesh filter (sieve opening 75 μm). The passed slurry was filtered again and dried. Thereby it was obtained spherical zinc oxide particles 18 having an average particle diameter of 33.1 μm.

### <<Evaluation of Spherical Zinc Oxide Particles>>

For evaluation of spherical zinc oxide particles, an average particle diameter, a variation coefficient (CV value) of particle diameter, and plasmon intensity were measured.

### <Average Particle Diameter and Variation Coefficient (CV Value) of Particle Diameter>

An average particle diameter and a variation coefficient (CV value) in particle diameter distribution were obtained based on scanning microscopic pictures (SEM images) of 100 particles. It was measured a diameter of a circle having an equivalent area of a particle picture taken from 100 particles. An average particle diameter of particles was thus obtained.

The variation coefficient in particle diameter distribution is determined by the following relationship.

Variation coefficient (%)=(Standard deviation in particle diameter distribution/Average particle diameter)×100

### <Evaluation of Plasmon Intensity>

Evaluation of plasmon intensity is done by forming an infrared sensor and by evaluating plasmon intensity and incident light angle dependency of plasmon intensity.

5 g of the produced spherical zinc oxide particles was dispersed in 100 mL of water. The dispersion liquid was dropped on a glass substrate to have a dried thickness of 1 μm. Thus, it was formed a layer containing the produced spherical zinc oxide particles. This was used as a plasmon sensor chip.

### <Incident Light Angle Dependency>

By using an ellipsometer, infrared light was made enter water of sample, and an intensity of the reflective light was measured. In the disposition of FIG. 1, irradiation was made with incident light having a wavelength of 1500 nm by using an ellipsometer (VASA, made by J. A. Woolam Japan Co. Ltd.). Two kinds of polarized light each having an incident angle θ₁ of 43° and 46° were irradiated. The evaluation was done based on the following evaluation criteria. The reflection angle θ₂ was fixed to be 46°.
o: The spectrum can be measured with two incident angles.
x: The spectrum can be measured with only one incident angle.

Here, “the spectrum can be measured” means the case that it is observed a peak having a reflection ratio of 5% or more.

### <Evaluation of Plasmon Resonance Intensity>

A plasmon resonance spectrum of water was measured using an FT-IR spectrometer (FTIR-6000 made by JASCO Co. Ltd.). It was determined an absorbing value of 1,500 nm, which is an absorption of OH group in water. A maximum value of the numerical values in Table is 1.00. A larger numerical value indicates that the plasmon resonance intensity is high.

The evaluation results are listed in Table 1. In Table 1, a particle diameter variation coefficient is abbreviated as a variation coefficient. A column of supplemental addition indicates “done” or “not done” of addition of at least one of the aqueous zinc solution and the aqueous metallic element solution into the reaction solution in the forming step of zinc compound precursor particles.

TABLE 1

| | | | | Evaluation of Zinc oxide | | | | | |
|---|---|---|---|---|---|---|---|---|---|
| | | | | particles | | | Evaluation of Plasmon | | |
| Zinc | Metal atom | | | | Average | | sensor chip | | |
| oxide | | Dope | | | particle | Variation | | Plasmon | |
| particles | | amount | Supplemental | Aspect | diameter | coefficient | Angle | resonance | |
| No. | Kind | (mol %) | addition | ratio | (nm) | (%) | dependence | intensity | Remarks |
| 1 | Ga | 10.00 | Not done | 1.08 | 310 | 5.1 | ∘ | 0.68 | Present invention |
| 2 | Ga | 0.01 | Not done | 1.06 | 430 | 6.2 | ∘ | 0.77 | Present invention |
| 3 | Ga | 7.00 | Not done | 1.05 | 350 | 4.8 | ∘ | 0.82 | Present invention |
| 4 | Ga | 5.00 | Not done | 1.07 | 380 | 4.3 | ∘ | 0.93 | Present invention |
| 5 | Eu | 10.00 | Not done | 1.06 | 300 | 5.0 | ∘ | 0.61 | Present invention |
| 6 | Ce | 10.00 | Not done | 1.10 | 290 | 7.2 | ∘ | 0.58 | Present invention |
| 7 | Pr | 10.00 | Not done | 1.09 | 310 | 6.1 | ∘ | 0.56 | Present invention |
| 8 | Sm | 10.00 | Not done | 1.07 | 250 | 5.8 | ∘ | 0.56 | Present invention |
| 9 | Gd | 10.00 | Not done | 1.08 | 280 | 5.5 | ∘ | 0.53 | Present invention |
| 10 | Tb | 10.00 | Not done | 1.09 | 300 | 6.7 | ∘ | 0.58 | Present invention |
| 11 | Nd | 10.00 | Not done | 1.08 | 290 | 5.7 | ∘ | 0.56 | Present invention |
| 12 | Yb | 10.00 | Not done | 1.07 | 280 | 5.1 | ∘ | 0.57 | Present invention |
| 13 | Ga | 7.00 | Done | 1.05 | 300 | 3.9 | ∘ | 0.90 | Present invention |
| 14 | Ga | 10.00 | — | — | — | — | x | 0.48 | Comparative example |
| 15 | Ga | 10.00 | — | 1.12 | 8000 | 8.2 | x | 0.45 | Comparative example |
| 16 | Ga | 10.00 | — | 1.10 | 350 | 12.4 | ∘ | 0.25 | Comparative example |
| 17 | Ga | 10.00 | — | 1.13 | 400 | 15.3 | ∘ | 0.34 | Comparative example |
| 18 | Ga | 10.00 | — | 1.15 | 7000 | 13.8 | x | 0.20 | Comparative example |

From the results in Table 1, it is clear that the zinc oxide particles 1 to 13 have higher sphericity, smaller average particle diameter, and smaller variation coefficient than the zinc oxide particles 14 to 18. Further, it is shown that when the zinc oxide particles 1 to 13 are used as a plasmon sensor chip, they exhibit high plasmon resonance intensity, and small angle dependence of incident angle.

A SEM image of the obtained zinc oxide particle number 3 was illustrated in FIG. 2. It is clear that they are spherical zinc oxide particles having high sphericity, a small average particle diameter, and a small variation coefficient.

### INDUSTRIAL APPLICABILITY

The present invention enables to provide the spherical zinc oxide particles having a particle diameter in a specific range and excellent in monodispersity and exhibiting high plasmon resonance intensity. The present invention also enables to provide a plasmon sensor chip having high sensitivity and small angle dependency in measurement by using these particles.

### DESCRIPTION OF SYMBOLS

1: Plasmon sensor
2: Substrate
3: Layer containing spherical zinc oxide particles
4: Plasmon sensor chip
5: Optical prism
6: Light source
7: Polarizing plate
8: Mounting section
9: Specimen
10: Light receiving section
θ₁: Incident angle
θ₂: Reflection angle

1. Spherical zinc oxide particles doped with a metallic element selected from the group consisting of: gallium, europium, cerium, praseodymium, samarium, gadolinium, terbium, neodymium and ytterbium,
wherein t e spherical zinc oxide particles have an average particle diameter in the range of 50 to 5,000 nm, and have a variation coefficient in particle diameter distribution in the range of 1.0 to 10%.

2. The spherical zinc oxide particles described in claim 1,
wherein a total dope amount of the metallic element is in the range of 0.01 to 10.00 mol %.

3. The spherical zinc oxide particles described in claim 1,
wherein a total dope amount of the metallic element is in the range of 0.01 to 7.00 mol %.

4. The spherical zinc oxide particles described in claim 1,
wherein the spherical zinc oxide particles have an average aspect ratio in the range of 1.00 to 1.15.

5. The spherical zinc oxide particles described in claim 1,
wherein the metallic element is gallium.

6. The spherical zinc oxide particles described in claim 1,
wherein the spherical zinc oxide particles have a variation coefficient in the range of 1.0 to 8.0%.

7. A method for producing spherical zinc oxide particles comprising the steps of:
forming zinc compound precursor particles by mixing an aqueous metallic element solution, an aqueous zinc solution, and an aqueous urea solution, the metallic element in the aqueous metallic element solution being one selected from the group consisting of: gallium, europium, cerium, praseodymium, samarium, gadolinium, terbium, neodymium and ytterbium; and
calcining the zinc compound precursor particles to obtain spherical zinc oxide particles doped with the metallic element.

8. The method for producing spherical zinc oxide particles described in claim 7,
wherein in the step of forming the zinc compound precursor particles, at least one of the aqueous zinc solution, the aqueous metallic element solution, and the aqueous urea solution is added into a reaction solution in which formation of the zinc compound precursor particles is in progress.

9. A plasmon sensor chip provided with: the spherical zinc oxide particles described in claim 1; and a substrate.

10. The plasmon sensor chip described in claim 9 having a transmitting property and having a refractive index in the range of 1.30 to 4.00.
